(19) United States
(12) Patent Application Publication
(10) Pub. No.: US 2013/0008989 A1
(43) Pub. Date: Jan. 10, 2013

(54) ROLLER MILL

(75) Inventor: Otto Heinemann, Ennigerloh (DE)

(73) Assignee: LOESCHE GMBH, Duesseldorf (DE)

(21) Appl. No.: 13/583,900

(22) PCT Filed: Feb. 22, 2011
(86) PCT No.: PCT/EP11/00837

§ 371 Date: Sep. 10, 2012

(30) Foreign Application Priority Data
Mar. 26, 2010 (DE) 102010012893.7

(51) Int. Cl. B02C 4/28; B02C 4/32

(52) U.S. Cl. 241/231; 241/227

(57) ABSTRACT

In this roller mill (3) with a vertical axis (1), the grinding rollers (5) are mounted via the grinding roller shafts (6) in bearing housings (7) which are equipped with rolling bearings and which are fastened outside the roller mill housing on concrete foundations (9). Between the bearing housings (7) of the grinding roller bearing arrangement and the concrete foundations (9) are situated so-called scissor lift tables (8) which, by means of an integrated hydropneumatic suspension, press the grinding rollers inside the roller mill housing onto the material for grinding situated on the grinding plate (3) and carry out the grinding process. Moreover, the scissor lift tables (8) have the function of stabilizing the grinding rollers (3) against tangential forces and of allowing only a pure vertical movement for the grinding rollers. This means that a tilting of the grinding rollers is effectively prevented by the scissor lift tables. The scissor lift tables with the grinding roller units fastened thereon stand on fixable movable bases, with the result that the grinding roller units can be moved individually out of the roller mill housing or the grinding rollers can be slightly displaced radially on the grinding plate.

The invention relates to a roller mill corresponding to the introductory clause of claim 1.

A roller mill of the known type is described in the patent DE 38 01 728 C2. An oblique position of the grinding roller upon the deflection during grinding is not prevented here, which leads to the grinding roller changing its rolling position on the grinding plate, the grinding roller rolling only on the grinding roller edge, the efficiency of the grinding decreasing and wear arising predominantly on the edge of the grinding roller. Mainly the wear pattern can be clearly observed with respect to roller mills known today.

A considerably better roller mill variant is described in DE 103 38 154 A1. Any oblique position of the grinding roller is indeed avoided here through the controller-guided roller bearing arrangement outside of the roller mill housing but through the deflection of the grinding roller an uncontrolled position displacement of the grinding roller on the grinding plate is inevitably unavoidable and this also leads to a more inefficient grinding.

It is thus an object of the invention to design a roller mill corresponding to the introductory clause of claim 1 in such a way that a construction is produced which reliably precludes the tiltings of the grinding rollers and offset of the grinding rollers during the grinding process on the grinding plate. These objects are achieved excellently through the characterising feature of claim 1. Useful embodiments of the invention are the subject matter of sub-claims.

The inventive roller mill consists of a roller mill housing with vertical axis. In the roller mill housing the grinding plate is rotationally mounted with its lower side on a vertical bearing ring. On the upper side of the grinding plate the grinding rollers located there roll over the grinding material lying on the grinding plate in order to reduce it. Two or more grinding rollers can be arranged. The grinding plate is set in rotation through a gear arranged below the grinding plate in the roller mill housing with vertical output and a drive motor erected outside of the roller mill housing. Furthermore it is possible also by means of driven grinding rollers, of which the drive motor gear units are located outside of the roller mill housing, to set the grinding plate in rotation. Different drive variants for the grinding plate are thus possible. Combinations of the drives described are also possible.

The grinding rollers are mounted via the grinding roller shafts in bearing housings equipped with roller bearings or friction bearings. While the grinding rollers roll inside the roller mill housing on the grinding plate, the bearing housings equipped with roller bearings or friction bearings for mounting the grinding rollers by means of the grinding roller shafts are located outside of the roller mill housing, fixed on scissor lift tables which are anchored on concrete foundations arranged outside of the roller mill housing. With hydro-pneumatic springs arranged in the scissor lift tables the grinding rollers are pressed via the grinding roller shafts inside the roller mill housing onto the grinding material lying on the grinding plate.

The objects of the scissor lift tables are to carry the grinding roller bearing arrangement, to fix the grinding rollers tangentially and radially on the grinding plate, to prevent a tilting of the grinding rollers, to transfer grinding forces from the grinding rollers onto the foundations and to facilitate the extension capacity of the grinding roller units. By means of adjustable stops inside the scissor lift tables the grinding rollers inside the roller mill housing above the grinding plate can be adjusted so that in case of insufficient coverage of the grinding plate with grinding material a zero gap can be set between the grinding rollers and the grinding plate. This prevents the grinding rollers from being able to lie on the grinding plate and then damaging it. By means of the scissor lift tables individual grinding roller units are removed from the grinding process through lifting in order to be able to reduce the grinding performance of the roller mill or to be able to carry out repairs more easily.

Grinding roller, grinding roller shaft, bearing of the grinding roller in the bearing housing and scissor lift tables form a machine technical unit which is provided with all supply lines and supply connections ready for use. A rapid and complete exchange of the grinding roller units is thereby guaranteed even with operation-related high temperatures of individual machine parts as the roller mill inner space does not have to be entered.

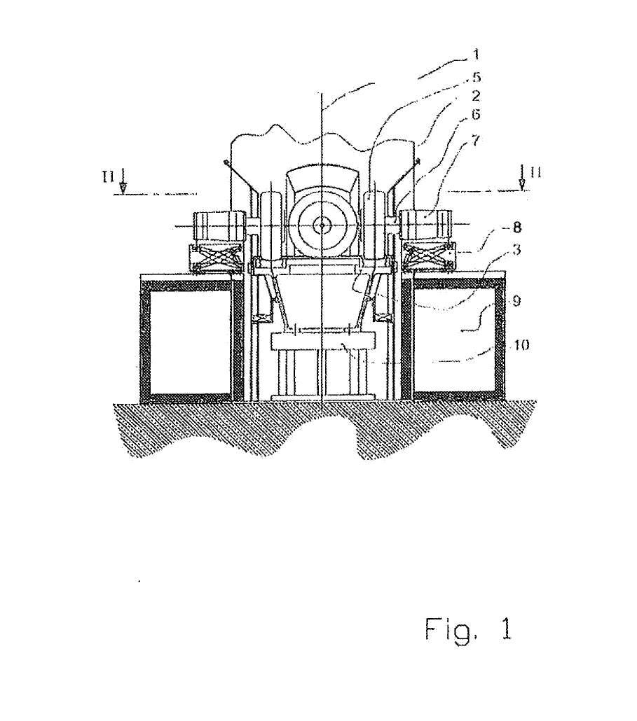

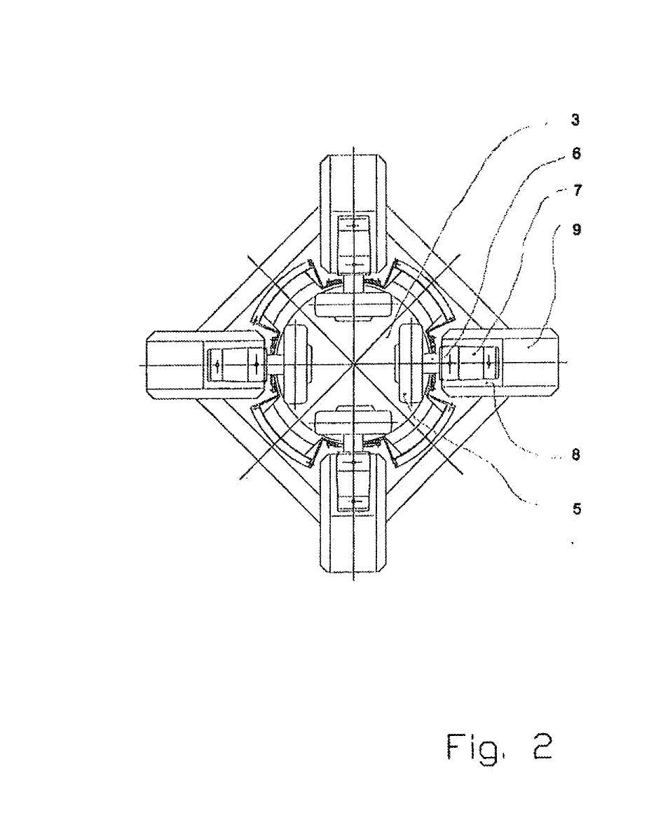

The invention is explained by way of example by reference to the drawings according to FIG. 1 and FIG. 2, whereby FIG. 1 shows a vertical section and FIG. 2 a top view corresponding to the line II-II in FIG. 1. The example does not show any drive motors and gears as these details are regarded as known. Gas supplies and possibly present classifiers or separators above the roller mill which are not subject matter of claims are not shown in the drawings either. The example of the inventively designed roller mill has four grinding rollers 5 evenly distributed around the periphery of the roller mill, such grinding rollers forming a machine unit with the grinding roller shafts 6, the bearing housing 7 and the scissor lift tables 8. The grinding plate 3 rotates in the mill housing 2 about the vertical mill axis 1, carried by the axial support bearing 10. The machine unit is fixedly anchored to the scissor lift tables 8 on the concrete bases 9 but releasably anchored for a disassembly of the machine unit.

The roller mill consists of a cylindrical mill housing with vertical axis in which there is a grinding plate which is rotationally mounted on its lower side on a vertical bearing ring. Above the grinding plate the grinding rollers are situated inside the roller mill housing which reduce the grinding material located on the grinding plate by rolling over it. Depending upon the size of the roller mill two or more grinding rollers can be provided. The grinding plate is set in rotation by a central drive arranged below the grinding plate or via driven grinding rollers. Different drive variations of the roller mill are thus possible or combinations of the individual drive variations are achievable. The grinding rollers are mounted via the grinding roller shafts in bearing housings equipped with roller bearings which are fixed outside the roller mill housing on concrete foundations. So-called scissor lift tables are located between the bearing housings of the grinding roller bearing arrangement and the concrete foundations, which scissor lift tables press, by means of an integrated hydro-pneumatic spring system, the grinding rollers inside the roller mill housing onto the grinding material located on the grinding plate and carry out the grinding process. The scissor lift tables additionally have the function of stabilising the grinding rollers against tangential forces and only allowing a pure vertical movement for the grinding rollers. This means that a tilt of the grinding rollers is effectively suppressed by the scissor lift tables. The scissor lift tables with the grinding roller units fixed thereon are located on fixable bases, whereby the grinding roller units can be moved individually out of the roller mill housing or the grinding rollers can be radially slightly displaced on the grinding plate.

1. Roller mill containing:
a) a mill housing 2 with vertical axis 1,
b) an axial support bearing 10 supporting the grinding plate 3 rotating in the mill housing 2,
c) the grinding rollers 5 rolling on the grinding material lying on the grinding plate 3 with the grinding roller shafts 6 and the bearing housing 7 with the bearings,
characterised in that
the machine unit, consisting of the grinding roller 5, the grinding roller shaft 6 and the bearing housing 7 with the shaft bearings is anchored by means of a scissor lift table on the concrete base 9.

2. Roller mill according to claim 1, characterised in that the scissor lift table contains more than two scissor blades.

3. Roller mill according to claim 1, characterised in that within the scissor lift table at least two hydro-pneumatic tension springs press the machine unit, consisting of the grinding roller 5, the grinding roller shaft 6 and the bearing housing 7 with the shaft bearings contained therein, with the grinding roller onto the grinding material lying on the grinding plate.

4. Roller mill according to claim 1, characterised in that all supply lines for the machine unit, oil lines, water lines, power lines, measurement data lines and control data lines are mounted in the lower part of the scissor lift table ready for use.

5. Roller mill according to claim 1, characterised in that the machine unit, fully assembled together with the scissor lift table and all supply lines located therein, can be released from the concrete foundation and removed from the work range of the roller mill.

6. Roller mil according to claim 1, characterised in that a machine unit, fully assembled with the scissor lift table and all supply lines located therein can be placed on the concrete base and fixed.
